(19) United States
(12) Patent Application Publication
(10) Pub. No.: US 2009/0314864 A1
(43) Pub. Date: Dec. 24, 2009

(54) Hydraulic jet mill

(76) Inventor: George Kruse, Rapid City, SD (US)

Correspondence Address: Gene R. Woodle, 3516 Woodle Drive, Rapid City, SD, 57702, US

(21) Appl. No.: 12/214,428

(22) Filed: Jun. 19, 2008

(51) Int. Cl. B02C 19/06

(52) U.S. Cl. 241/39

(57) ABSTRACT

An hydraulic jet mill is disclosed in which a high pressure line and a low pressure line are introduced into at least one jet (or nozzle). The jet is configured such that there is an orifice at the forward end of the jet and the cross sectional area of the interior of the rearward portion of the jet is significantly greater than the cross sectional area of the interior of the forward portion of the jet. There is an incompressible liquid such as water in the high pressure line and a material to be milled in a slurry with an incompressible liquid such as water in the low pressure line. The high pressure line is introduced into the rearward portion of the jet and the low pressure line is introduced through a venturi into the forward portion of the jet. The contents of the high pressure line and the low pressure line mix and are forced out of the orifice at high velocity. The material is milled when it strikes either an impingement plate or an opposed second jet.

### BACKGROUND OF THE INVENTION

1. Field of the Invention

The present invention relates generally to the milling of materials and more specifically to milling materials by shooting opposed jets of the materials and a carrying medium into one another or shooting the material in a carrying medium onto an impingement plate.

2. Background Information

For hundreds of years, mankind has struggled to develop methods of reducing the size of ore, other minerals and other materials from wheat to corn. Dozens of different types of mills have been invented to crush or mill materials. In a hammer mill, for example, a series of “hammers” literally pound the material to crush it to a smaller size. Most often, after milling, the material is sized usually using one or more screens. Material which passes through a screen having the appropriate mesh size is usually sold or used in a manufacturing process, while material which doesn't pass through the appropriate screen is too large and is sent back to the mill.

In recent years, there has been increased interest in milling certain materials to a very small size, usually referred to as nano sized particles. Generally, a nano particle is less than one micron. Small particles down to nano sized particles are preferred over larger particles for many purposes because they have a much greater surface area per weight than larger particles of the same material. For example, nano sized mica powder has approximately ten times as much surface area per gram as 75 micron sized mica powder. The larger surface area per weight is desirable in many circumstances because it gives a second material a greater area to bond with and, often, increases the effectiveness of chemical reactions.

One of the most promising possible avenues for successfully milling minerals and similar materials to a nano size involves the use of a jet mill. Jet mills are well known in the prior art as is demonstrated by the patents to Work (U.S. Pat. No. 2,846,250; Aug. 5, 1958) and Muschelknautz et al. (U.S. Pat. No. 3,876,156; Apr. 8, 1975). In Work the material to be pulverized is mixed with a vaporizable liquid such as water to form a slurry. The slurry is separated into two equal streams which pass through a heater to heat the slurry to a temperature and pressure such that part way through the heater a relatively low velocity dispersion of solid particles in a gas if formed. The two streams are then discharged into a “disintegrator chamber” such that the two streams flow through a pair of opposed nozzles and collide with each other. The collision is sufficient to mill the material. In Muschelknautz et al. a gas is forced through a gas propellant pipe and then over and under a stock container such that material in the stock container mixes with the gas and both pass through a jet tube. The material and the gas strike an impact plate where the material is pulverized.

Both the above patents and other known jet mill prior art use gas streams for milling. High pressure streams of liquid/material slurries are extremely abrasive and cause great wear on delivery tubes and nozzles.

Ethanol may be produced from biomass which is considered to be any naturally occurring organic material containing cellulose. For purposes of this discussion, biomass refers to wood waste including slash, pine needles, sawdust, and any other currently unwanted wood material and any other material containing cellulose including grasses such as switch grass. Biomass is often used to describe any plant material. Some ethanol is currently being produced from biomass such as wood waste, but such production is currently significantly more expensive and less efficient than production of ethanol from grains.

Biomass contains cellulose and hemicellulose which may be converted into C6 sugars such as glucose and C5 sugars such as xylose. The structure of these materials in biomass may be considered as a long strand of crystalline cellulose surrounded by a layer of hemicellulose with both the cellulose and hemicellulose surrounded by a layer of what is known as lignin. Hemicelluloses are generally linear or branched polymers of C5 sugars, but may include other compounds. Lignin is a polymetric matrix of aromatic structures. One of the key factors in efficiently producing ethanol from wood waste or similar organic material is to break apart the lignin and other structural elements so that the cellulose and hemicellulose are exposed. This is sometimes called exfoliation.

Because of differences in the bonding of compounds in biomass and because of the presence of the lignin sheath, it is much more difficult to process the cellulose and hemicellulose in wood waste type biomass than it is to process the starches in grains. Most often, an acid hydrolysis process is currently used to extract and reduce the hemicellulose and cellulose to C5 and C6 sugars. Because the process uses sulfuric acid, process equipment such as pumps and pipes must be corrosion resistant and are much more expensive than those used to process grains. The sulfuric acid process also generates a neutralization byproduct, calcium sulfate or gypsum, which must be disposed of. Using the acid hydrolysis process, about 58 gallons of ethanol can be produced from a ton of biomass. Prices vary, of course, but a ton of biomass delivered to a processing site costs approximately one half as much as a ton of grain delivered to a processing site. Even though the feed stock costs much less, acid hydrolysis of biomass to ethanol is not generally economically feasible; because the plant costs are higher than producing ethanol from grains and the yields are lower.

In some instances it may be desirable to process biomass in such a manner that it may be used directly to create energy rather than processing the biomass into, for instance, ethanol. For example, switch grass or wood waste could be processed into a form of briquette and burned to produce electricity. The processed biomass could also be used as a supplement to other fuels which are burned to create energy. Switch grass could be processed, for instance, and burned with coal to produce electricity.

The instant invention, an hydraulic jet mill, is believed to solve, in a unique and effective manner, a variety of problems relating to the milling of minerals or other materials to very small sizes including reduction of wear and abrasion on pipes and other apparatus.

The ideal hydraulic opposed jet mill should be capable of milling materials to a small size including down to nano size. The ideal hydraulic jet mill should also provide an apparatus which greatly reduces abrasion wear on pumps, pipes, jets or nozzles and other elements. The ideal hydraulic jet mill should also provide an apparatus which can efficiently and effectively shear open the lignin sheath which surrounds the cellulose and hemicellulose in cellulosic materials to facilitate the productions of ethanol from cellulosic material. The ideal hydraulic jet mill should also be capable of introducing a milling agent to facilitate rapid milling. The ideal hydraulic jet mill should also be capable of providing for the introduction of a second material in addition to the material to be milled. The ideal hydraulic jet mill should also be simple, inexpensive, rugged, and easy to use.

### SUMMARY OF THE INVENTION

The hydraulic jet mill of the instant invention is an apparatus which ends at a pair of opposed jets or nozzles through which a material/water slurry is forced. The two streams of slurry collide with each other with sufficient energy to mill the material. In the following example, the material, wood particles, is used; but the apparatus could be used to mill a variety of minerals and other materials. Although much of the following describes milling using opposed jet nozzles, another embodiment of the invention is one or more jets which are not opposed, but in which the material/water slurry strikes an impact or impingement plate rather than a stream from an opposed jet to cause milling.

The process begins with the introduction of wood particles which have been reduced to a appropriate size using some conventional milling process into a incompressible liquid such as water. The slurry is separated into two roughly equal streams, referred to as the slurry lines, and pumped at low pressure and velocity to the forward portions of each of the two jets. This alleviates the common problem of abrasion in jet mills, because the material, which may be abrasive, does not travel through lines and apparatus at high velocity or pressure.

A conventional positive displacement pump pumps water or other incompressible liquid into a water line at low velocity. The water line splits into two self equalizing low velocity lines and the water is introduced into the rearward portion of each of the two jets. The cross sectional area of the rearward portion of the jets is significantly greater than the cross sectional area of the forward portion of the jets. This causes the velocity of the water or other incompressible liquid to increase.

The now high velocity water sprays out of the jets. Because the cross sectional area of the jets grows smaller from the rearward portion to the forward portion, the pressure of the water near the forward portion of the jets becomes sufficiently small that the relatively low pressure wood particle/water slurry enters the interior of the jet and mixes with the water within the jet. Wood particles collide with high energy where the jets come together in a milling chamber. The openings in the forward ends of the jets are not only opposed, but are also coplanar.

The milling chamber is of sufficient size that the internal pressure is near ambient pressure. The milled wood particle slurry is drawn from the milling chamber and transported to a conventional centrifuge for de-watering. The majority of the water is separated from the milled wood particles and recycled to both the low pressure slurry line and the water line. The dewatered material may then be transported for any necessary further processing, which may include further drying, using conventional means.

In another embodiment of the instant invention, the high pressure water line and the low pressure wood particle/water slurry line have different functions. Because wood particles aren't particularly abrasive, it is possible for the wood particle/water slurry to pass through the pump and be injected into the rear of the jets. That is, the high pressure line or water line is now the wood particle/water slurry line. The low pressure line or slurry line may be used to inject any of a variety of other materials including surfactants, enzymes, or yeast. For example, if the wood particles were to be used to make ethanol, the wood particles could be run through the pump and milled until they were sufficiently small or have the appropriate configuration. Enzymes could then be introduced through the low pressure line to begin the enzymatic process necessary to convert cellulose and hemicellulose into ethanol.

In another embodiment of the instant invention, a milling agent such as mica particles is added to the wood particle/water slurry. The mica which is much harder and “sharper” than the wood particles interacts with the wood particles to speed up the milling process. The milling agent acts to shear and grind the wood particles which exfoliates the lignin sheath which surrounds the cellulose and hemicellulose in the wood. In experimental studies, mica was added to the wood particle/water slurry in such amounts that there was 20 percent mica and 80 percent wood by weight. In these experiments, the wood was milled to appropriate size and configuration much more quickly and completely than without added mica. The milling agent could be introduced through what has been described above as the low pressure line or slurry line to reduce abrasion on the apparatus and the wood particle/water slurry could be introduced through what has been described above as the high pressure line or water line.

In another embodiment of the instant invention, switch grass or a similar material is milled using either the opposed jet mill or the jet and impingement mill as described above to a size between 200 and 50 microns. The material is then dried and formed into cakes or cubes which may be used for a variety of purposes including being mixed with coal for use in coal fired power plants.

One of the major objects of the hydraulic jet mill of the instant invention is to mill minerals or other materials to small size down to nano size.

Another objective of the present invention is to provide an apparatus which greatly reduces abrasion wear on pumps, pipes, nozzles, and other elements.

Another objective of the present invention is to provide an apparatus which can efficiently and effectively shear open the lignin sheath which surrounds the cellulose and hemicellulose in cellulosic materials to facilitate the productions of ethanol from cellulosic material.

Another objective of the present invention is to provide an apparatus which is capable of introducing a milling agent to facilitate rapid milling.

Another objective of the present invention is to provide an apparatus which is capable of providing for the introduction of a second material in addition to the material to be milled.

Another objective of the present invention is to provide a milling process which is simple, inexpensive, rugged, and easy to use.

These and other features of the invention will become apparent when taken in consideration with the following detailed description and the drawings.

### BRIEF DESCRIPTION OF THE DRAWINGS

FIG. 1 is a side view of a jet of the hydraulic jet mill of the instant invention;

FIG. 2 is a side view of two of the jets of the instant invention opposed at 180 degrees;

FIG. 3 is a side view of one of the jets of the instant invention used with an impingement plate; and

FIG. 4 is a side view of three of the jets of the instant invention all opposed to each other.

### DESCRIPTION OF A PREFERRED EMBODIMENT

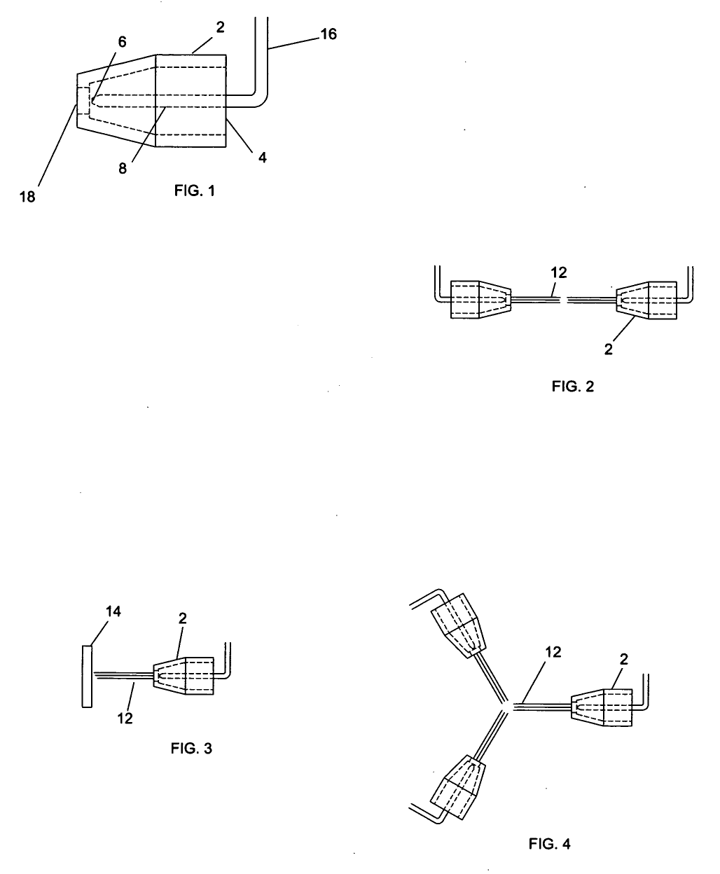

Referring to the drawings, FIGS. 1, through 5, there is shown a preferred form of the hydraulic jet mill of the instant invention. Water is used in the following description, but other incompressible fluids could be used if desired. The following describes an hydraulic jet mill; but, in another embodiment, rather than having opposed jets, the mill would employ one or more jets which were not opposed, but directed toward an impact or impingement plate. Wood particles are used in the following description, but other materials could be milled in a similar manner.

A number of processes could be used to implement the instant invention. A preferred process begins with the introduction of wood particles which have been reduced to a size such that the apparatus is capable of handling the material using some conventional milling process into a incompressible liquid such as water to form a slurry. The slurry is separated into two roughly equal streams and pumped at low pressure and velocity to the forward portions of each of the two jets. These are considered to be the slurry lines.

A conventional positive displacement pump pumps water or other incompressible liquid into a water line at low velocity. The water line splits into two self equalizing low velocity lines and the water is introduced into the rearward portion of each of the two jets. The cross sectional area of the rearward portion of the jets is significantly greater than the cross sectional area of the forward portion of the jets. This causes the velocity of the water or other incompressible liquid to increase.

The high velocity water sprays out of the jets. Because the cross sectional area of the jets grows smaller from the rearward portion to the forward portion, the pressure of the water near the forward portion of the jets becomes sufficiently small that the relatively low pressure wood particle/water slurry enters the interior of the jet and mixes with the water within the jet. That is, the slurry lines are introduced near the front portion of the jets and the water lines are introduced into the rearward portion of the jets. Wood particles collide with high energy where the jets come together in a milling chamber. The openings in the forward ends of the jets are not only opposed, but are also coplanar.

The milling chamber is of sufficient size that the internal pressure is near ambient pressure. The milled wood particle slurry is drawn from the milling chamber and transported to a conventional centrifuge for de-watering. The majority of the water is separated from the milled wood particles and recycled to both the low pressure slurry line and the water line. The “cake” or damp milled wood particles are transported to a conventional dryer and then to a conventional air classifier for sorting of the material by particle size. The separated small sized particles may be packaged and shipped as desired. The large sized particles may be packaged and shipped or reintroduced to the slurry stream.

Now referring to FIG. 1, a side view of one of the jets 2 of the instant invention is shown. The low velocity water enters said jets 2 at the rear of said jet 2 as indicated at 4 through the water line (not shown). The low pressure slurry is introduced near the forward portion of said jet 2 as indicated at 6 through a venturi tube 8 which is connected to the slurry line 16. The venturi tube 8 is introduced through the rear of said jets 2 with the outlet near the forward portion of said jet 2. The low velocity water enters through a rearward opening in said jet 2. Because the cross sectional area of said jet 2 is relatively large at 4 compared to the cross sectional area at 6; the velocity of the fluid at 4 is relatively low and the static pressure is relatively high. At 6, the velocity is relatively high and the static pressure sufficiently reduced, that the low pressure slurry may enter said jet 2 at 6. This greatly reduces the abrasion of the particles on the various elements of the hydraulic jet mill, because the particles are moving at high velocity only from 6 to the tip of said jet 2. Said jet 2 must be configured and the difference in pressure between the water line and said slurry line 16 must be set such that the slurry leaves said venturi 8 at 6 and is not forced back into said slurry line 16. The combined water and slurry sprays out of said jet 2 through an orifice 18. The exit velocity of this stream through the orifice 18 may be adjusted as necessary to accommodate different materials or to mill to different sizes.

Still referring to FIG. 1, in another embodiment of the instant invention, a wood particle/water slurry is introduced at the rear of said jet 2 as indicated at 4. That is, this wood particle/water slurry passes through the pump and is milled as described above. Other materials such as surfactants, enzymes, or yeast could be introduced through said venturi tube 8 as indicated at 6.

Now referring to FIG. 2, a wood particle/water slurry could be injected into two of said jets 2 through two of said jets 2 as described above. The two of said jets 2 would be positioned such that the streams of material and incompressible liquid 12 would strike each other. The wood particles in the wood particle/water slurry would then be milled to appropriate size and configuration to be used, for instance, in the production of ethanol. Where biomass was to be pretreated for production of ethanol, the biomass should collide with sufficient energy to exfoliate at least a portion of the biomass. If the particles aren't sufficiently small after being processed once they may be processed as many more times as is necessary.

Referring now to FIG. 3, a side view of one of said jets 2 and an impingement plate 14 is shown. In this embodiment, rather than colliding with each other as in FIG. 2, the wood particle/slurry stream 12 strikes the impingement plate 14. In this embodiment the wood particles are also milled by the force of the collision, but there is approximately one half of the energy as is provided in the embodiment shown in FIG. 2.

Referring now to FIG. 4, a side view of multiple opposed jets 2 is shown. In this embodiment, said jets 2 are opposed to each other at angles of 120 degrees. Said wood particle/slurry streams 12 strike each other at the center point between the three jets 2. This embodiment has the advantage that wood particle slurry 12 from one of said jets 2 does not strike another of said jets 2. In the embodiment shown in FIG. 2, part of said wood particle/slurry 12 from one of said jets 2 can strike the other of said jets 2 and cause wear and abrasion.

In another embodiment of the instant invention, a milling agent such as mica may be introduced into the wood particle/water slurry. The mica which is much harder and “sharper” than the wood particles interacts with the wood particles to speed up the milling process. The milling agent acts to shear and grind the wood particles which exfoliates the lignin sheath which surrounds the cellulose and hemicellulose in the wood. It will be understood that other materials than wood could be milled using the instant invention and other materials than mica could be used as a milling agent. In this embodiment, the milling agent would be introduced through said venturi 8 to reduce abrasion and wear and the wood particle/water slurry would be introduced at 4 where the incompressible liquid is introduced as described in the other embodiments described above.

In the above described embodiments, the wood particles are not only milled to a small size, but are exfoliated. This causes a much greater exposure of cellulose and hemicellulose than reducing the size of the wood particles using conventional milling techniques. Because more of the cellulose and hemicellulose is exposed, the manufacture of ethanol using this process is much more efficient than when using conventional methods.

In the preferred embodiment, all elements are conventional and may be secured from a variety of sources with the exception of said jets 2. Said jets 2 are manufactured from an alloy such as AR steel, Ni-hard steel, or a ceramic which is very resistant to abrasion. All elements which transport slurry are also made from abrasion resistant material.

While preferred embodiments of this invention have been shown and described above, it will be apparent to those skilled in the art that various modifications may be made in these embodiments without departing from the spirit of the present invention.

I claim:

1. An hydraulic jet mill for reducing the size of a material comprising:
(1) a jet having a forward end and a rearward end and having an open orifice at the forward end; the interior of the rearward end of the jet being in communication with the orifice; and the cross sectional area of the interior of said jet at its rearward end being larger than the cross sectional area of the interior of said jet at it forward end;
(2) a venturi through which a slurry of an incompressible liquid and the material may be introduced into the interior of the forward end of said jet rearward of said orifice;
(3) means for introducing an incompressible liquid into the rearward portion of the interior of said jet at sufficient pressure and velocity that the incompressible liquid and the slurry exit said jet through said orifice; and
(4) an impingement plate positioned forward of said orifice such that the stream of incompressible liquid and material strikes the impingement plate;
whereby a slurry of material and an incompressible liquid may be introduced into said jet under pressure near the forward end of said jet; an incompressible liquid may be introduced into the rearward end of said jet; and the slurry and the incompressible liquid exit said orifice and strike said impingement plate and a portion of the material is reduced in size.

2. The hydraulic jet mill of claim 1 in which the stream leaving said jet collides with a stream leaving at least one other jet rather than said impingement plate.

3. The hydraulic jet mill of claim 1 in which the slurry of material and incompressible liquid is introduced into the rearward portion of said jet and a second material is introduced through the venturi.

4. The hydraulic jet mill of claim 1 in which the slurry of material and incompressible liquid is introduced into the rearward portion of said jet and a milling agent is introduced through the venturi.

5. The hydraulic jet mill of claim 2 in which the slurry of material and incompressible liquid is introduced into the rearward portion of said jet and a second material is introduced through the venturi.

6. The hydraulic jet mill of claim 2 in which the slurry of material and incompressible liquid is introduced into the rearward portion of said jet and a milling agent is introduced through the venturi.

7. An hydraulic jet mill for pretreating biomass to be used for the production of ethanol comprising:
(1) a jet having a forward end and a rearward end and having an open orifice at the forward end; the interior of the rearward end of the jet being in communication with the orifice; and the cross sectional area of the interior of said jet at its rearward end being larger than the cross sectional area of the interior of said jet at it forward end;
(2) a venturi through which a slurry of an incompressible liquid and the biomass may be introduced into the interior of the forward end of said jet rearward of said orifice;
(3) means for introducing an incompressible liquid into the rearward portion of the interior of said jet at sufficient pressure and velocity that the incompressible liquid and the slurry exit said jet through said orifice; and
(4) an impingement plate positioned forward of said orifice such that the stream of incompressible liquid and biomass strikes the impingement plate with sufficient energy to exfoliate the biomass and reduce it in size;
whereby a slurry of biomass and an incompressible liquid may be introduced into said jet under pressure near the forward end of said jet; an incompressible liquid may be introduced into the rearward end of said jet; and the slurry and the incompressible liquid exit said orifice and strike said impingement plate and a portion of the biomass is reduced in size and exfoliated.

8. The hydraulic jet mill of claim 7 in which the stream leaving said jet collides with a stream leaving at least one other jet rather than said impingement plate.

9. The hydraulic jet mill of claim 7 in which the slurry of biomass and incompressible liquid is introduced into the rearward portion of said jet and a second material is introduced through the venturi.

10. The hydraulic jet mill of claim 7 in which the slurry of biomass and incompressible liquid is introduced into the rearward portion of said jet and a milling agent is introduced through the venturi.

11. The hydraulic jet mill of claim 8 in which the slurry of biomass and incompressible liquid is introduced into the rearward portion of said jet and a second material is introduced through the venturi.

12. The hydraulic jet mill of claim 8 in which the slurry of biomass and incompressible liquid is introduced into the rearward portion of said jet and a milling agent is introduced through the venturi.

13. An hydraulic jet mill for treating biomass to be burned for the production of heat comprising:
(1) a jet having a forward end and a rearward end and having an open orifice at the forward end; the interior of the rearward end of the jet being in communication with the orifice; and the cross sectional area of the interior of said jet at its rearward end being larger than the cross sectional area of the interior of said jet at it forward end;
(2) a venturi through which a slurry of an incompressible liquid and the biomass may be introduced into the interior of the forward end of said jet rearward of said orifice;
(3) means for introducing an incompressible liquid into the rearward portion of the interior of said jet at sufficient pressure and velocity that the incompressible liquid and the slurry exit said jet through said orifice;
(4) an impingement plate positioned forward of said orifice such that the stream of incompressible liquid and biomass strikes the impingement plate with sufficient energy to reduce the biomass to a size between 50 and 200 microns; and
(5) means for drying the biomass and forming it into briquettes;
whereby a slurry of biomass and an incompressible liquid may be introduced into said jet under pressure near the forward end of said jet; an incompressible liquid may be introduced into the rearward end of said jet; and the slurry and the incompressible liquid exit said orifice and strike said impingement plate and a portion of the biomass is reduced in size and exfoliated.

14. The hydraulic jet mill of claim 13 in which the stream leaving said jet collides with a stream leaving at least one other jet rather than said impingement plate.

15. The hydraulic jet mill of claim 13 in which the slurry of biomass and incompressible liquid is introduced into the rearward portion of said jet and a second material is introduced through the venturi.

16. The hydraulic jet mill of claim 13 in which the slurry of biomass and incompressible liquid is introduced into the rearward portion of said jet and a milling agent is introduced through the venturi.

17. The hydraulic jet mill of claim 14 in which the slurry of biomass and incompressible liquid is introduced into the rearward portion of said jet and a second material is introduced through the venturi.

18. The hydraulic jet mill of claim 14 in which the slurry of biomass and incompressible liquid is introduced into the rearward portion of said jet and a milling agent is introduced through the venturi.
